(19) United States
(12) Patent Application Publication
(10) Pub. No.: US 2010/0311874 A1
(43) Pub. Date: Dec. 9, 2010

(54) METHOD FOR PREPARING THERMOPLASTIC COMPOSITIONS BASED ON PLASTICIZED STARCH AND RESULTING COMPOSITIONS

(75) Inventors: Leon Mentink, Lille (FR); Didier Lagneaux, Bluffy (FR); Jerome Gimenez, Villeurbanne (FR)

Correspondence Address: YOUNG & THOMPSON, 209 Madison Street, Suite 500, Alexandria, VA, 22314, US

(73) Assignee: ROQUETTE FRERES, Lestrem (FR)

(21) Appl. No.: 12/864,511

(22) PCT Filed: Jan. 29, 2009
(86) PCT No.: PCT/FR2009/050135

§ 371 Date: Jul. 26, 2010

(30) Foreign Application Priority Data
Feb. 1, 2008 (FR) 0850659

(51) Int. Cl. C08L 3/02; C08L 3/00

(52) U.S. Cl. 524/48; 524/47; 524/53; 524/52

(57) ABSTRACT

A starch-based composition includes: (a) at least 51% by weight of a plasticized amylaceous composition including starch and a plasticizer for the starch, obtained by thermomechanically mixing granular starch and a plasticizer for the starch, (b) at most 49% by weight of at least one non-amylaceous polymer, and (c) a bonding agent having a molecular mass of less than 5000, including at least two functions, at least one which is capable of reacting with the plasticizer and at least another of which is capable of reacting with the starch and/or the non-amylaceous polymer, these amounts being expressed with respect to solids and relative to the sum of (a) and (b), a method for preparing such a composition and a thermoplastic composition obtained by heating such a composition.

The present invention relates to novel starch-based compositions and thermoplastic starchy compositions obtained from the latter, and also to the methods of preparing these compositions.

The expression “thermoplastic composition” is understood within the present invention to mean a composition which, reversibly, softens under the action of heat and hardens by cooling. It has at least one glass transition temperature (TO below which the amorphous fraction of the composition is in the brittle glassy state, and above which the composition may undergo reversible plastic deformations. The glass transition temperature or at least one of the glass transition temperatures of the starch-based thermoplastic composition of the present invention is preferably between −50° C. and 150° C. This starch-based composition may, of course, be formed by processes conventionally used in plastics processing, such as extrusion, injection molding, molding, blow molding and calendering. Its viscosity, measured at a temperature of 100° C. to 200° C., is generally between 10 and 10⁶ Pa·s.

Preferably, said composition is “thermofusible”, that is to say that it can be formed without application of high shear forces, that is to say by simple flowing or simple pressing of the molten material. Its viscosity, measured at a temperature of 100° C. to 200° C., is generally between 10 and 10³ Pa·s.

In the current context of climate changes due to the greenhouse effect and to global warming, of the upward trend in the costs of fossil raw materials, in particular of oil from which plastics are derived, of the state of public opinion in search of sustainable development, more natural, cleaner, healthier and more energy-efficient products, and of the change in regulations and taxations, it is necessary to provide novel compositions derived from renewable resources, which are suitable, in particular, for the field of plastics, and which are simultaneously competitive, designed from the outset to have only few or no negative impacts on the environment, and technically as high-performance as the polymers prepared from raw materials of fossil origin.

Starch constitutes a raw material that has the advantages of being renewable, biodegradable and available in large amounts at an economically advantageous price compared to oil and gas, used as raw materials for current plastics.

The biodegradable nature of starch has already been exploited in the manufacture of plastics, in accordance with two main technical solutions.

The first starch-based compositions were developed around thirty years ago. The starches were then used in the form of mixtures with synthetic polymers such as polyethylene, as filler, in the native granular form. Before dispersion in the synthetic polymer constituting the matrix, or continuous phase, the native starch is preferably dried to a moisture content of less than 1% by weight, in order to reduce its hydrophilic nature. For this same purpose, it may also be coated with fatty substances (fatty acids, silicones, siliconates) or else be modified at the surface of the grains with siloxanes or isocyanates.

The materials thus obtained generally contained around 10%, at the very most 20% by weight of granular starch, because beyond this value, the mechanical properties of the composite materials obtained became too imperfect and reduced compared to those of the synthetic polymers forming the matrix. Furthermore, it appeared that such polyethylene-based compositions were only biofragmentable and not biodegradable as anticipated, so that the expected boom of these compositions did not take place. In order to overcome the lack of biodegradability, developments were subsequently carried out along the same principle by replacing the conventional polyethylene with oxidation-degradable polyethylenes or with biodegradable polyesters such as polyhydroxybutyrate-co-hydroxyvalerate (PHBV) or polylactic acid (PLA). Here too, the mechanical properties of such composites, obtained by mixing with granular starch, proved to be insufficient. Reference may be made, if necessary, to the excellent book “La Chimie Verte” [Green Chemistry], Paul Colonna, Editions TEC & DOC, January 2006, chapter 6 entitled “Matériaux à base d'amidons et de leurs dérivés” [Materials based on starches and on their derivatives] by Denis Lourdin and Paul Colonna, pages 161 to 166.

Subsequently, starch was used in an essentially amorphous and thermoplastic state. This state is obtained by plasticization of the starch by incorporation of a suitable plasticizer in an amount generally between 15 and 25% relative to the granular starch, by supplying mechanical and thermal energy. The U.S. Pat. No. 5,095,054 by Warner Lambert and EP 0 497 706 B1 by the applicant describe, in particular, this destructured state, having reduced or absent crystallinity, and means for obtaining such thermoplastic starches.

However, the mechanical properties of the thermoplastic starches, although they can be adjusted to a certain extent by the choice of the starch, of the plasticizer and of the usage level of the latter, are overall quite mediocre since the materials thus obtained are still very highly viscous, even at high temperature (120° C. to 170° C.) and very frangible, too brittle and very hard at low temperature, that is to say below the glass transition temperature or below the highest glass transition temperature.

Thus, the elongation at break of such thermoplastic starches is very low, always below around 10%, even with a very high plasticizer content of the order of 30%. By way of comparison, the elongation at break of low-density polyethylenes is generally between 100 and 1000%.

Furthermore, the maximum tensile strength of thermoplastic starches decreases very greatly when the level of plasticizer increases. It has an acceptable value, of the order of 15 to 60 MPa, for a plasticizer content of 10 to 25%, but reduces in an unacceptable manner above 30%.

Therefore, these thermoplastic starches have been the subject of numerous research studies aiming to develop biodegradable and/or water-soluble formulations having better mechanical properties by physical mixing of these thermoplastic starches, either with polymers of oil origin such as polyvinyl acetate (PVA), polyvinyl alcohols (PVOHs), ethylene/vinyl alcohol copolymers (EVOHs), biodegradable polyesters such as polycaprolactones (PCLs), polybutylene adipate terephthalates (PBATs) and polybutylene succinates (PBSs), or with polyesters of renewable origin such as polylactic acids (PLAs) or microbial polyhydroxyalkanoates (PHA, PHB and PHBV), or else with natural polymers extracted from plants or from animal tissues. Reference may again be made to the book “La Chimie Verte” [Green Chemistry], Paul Colonna, Editions TEC & DOC, pages 161 to 166, but also, for example, to patents EP 0 579 546 B1, EP 0 735 104 B1 and FR 2 697 259 by the applicant which describe compositions containing thermoplastic starches.

Under a microscope, these resins appear to be very heterogeneous and have small islands of plasticized starch in a continuous phase of synthetic polymers. This is due to the fact that the thermoplastic starches are very hydrophilic and are consequently not very compatible with the synthetic polymers. It results therefrom that the mechanical properties of such mixtures, even with addition of compatibilizing agents such as, for example, copolymers comprising hydrophobic units and hydrophilic units alternately, such as ethylene/acrylic acid copolymers (EAAs), or else cyclodextrins or organosilanes, remain quite limited.

By way of example, the commercial product MATER-BI of Y grade has, according to the information given by its manufacturer, an elongation at break of 27% and a maximum tensile strength of 26 MPa. Consequently, these composites today find restricted uses, that is to say uses limited essentially to the sole sectors of overwrapping, garbage bags, checkout bags and bags for certain rigid bulky objects that are biodegradable.

The destructuring of the semicrystalline native granular state of the starch in order to obtain thermoplastic amorphous starches can be carried out in a barely hydrated medium via extrusion processes. Obtaining a molten phase from starch granules requires not only a large supply of mechanical energy and of thermal energy but also the presence of a plasticizer or else risks carbonizing the starch.

Such plasticizers may be sugars, polyols or other low molecular weight organic molecules.

The amount of energy to be applied in order to plasticize the starch may advantageously be reduced by increasing the amount of plasticizer. In practice, the use of a plasticizer at a high level compared to the starch induces, however, various technical problems, among which mention may be made of the following:
a release of the plasticizer from the plasticized matrix from the end of the manufacture or during the storage time, so that it is impossible to retain an amount of plasticizer that is as high as desired and consequently to obtain a sufficiently flexible and film-forming material;
great instability of the mechanical properties of the plasticized starch which cures or softens as a function of the atmospheric moisture, respectively when its water content decreases or increases;
the whitening or opacification of the surface of the composition by crystallization of the plasticizer used at high dose, such as for example in the case of xylitol;
a tacky or oily nature of the surface, as in the case of glycerol for example;
a very poor water resistance, even more problematic when the plasticizer content is high. A loss of physical integrity is observed in water, so that the plasticized starch cannot, at the end of manufacture, be cooled by immersion in a bath of water as for conventional polymers. Therefore, its uses are very limited. In order to extend its usage possibilities, it is necessary to mix it with large amounts, generally greater than or equal to 60%, of polyesters or of other expensive polymers; and
a possible premature hydrolysis of the polyesters (PLA, PBAT, PCL, PET) optionally associated with the thermoplastic starch.

The present invention provides an effective solution to the problems mentioned above by proposing novel thermoplastic compositions based on starch and on non-starchy polymers, in which the plasticizer is covalently bonded to the starch and/or to the polymer by means of a coupling agent.

Indeed, the applicant has observed after numerous studies that, surprisingly and unexpectedly, the use of such a coupling agent made it possible to introduce an amount of plasticizer considerably higher than those described in the prior art into the compositions of the present invention in a stable manner, thus advantageously improving the properties of the final compositions.

Consequently, one subject of the present invention is a starch-based composition comprising:
(a) at least 51% by weight of a plasticized starchy composition constituted of starch and of an organic plasticizer thereof, obtained by thermomechanical mixing of granular starch and of a plasticizer thereof;
(b) at most 49% by weight of at least one non-starchy polymer; and
(c) a coupling agent having a molecular weight of less than 5000, preferably less than 1000, comprising at least two functional groups, of which at least one is capable of reacting with the plasticizer and at least one other is capable of reacting with the starch and/or the non-starchy polymer, these amounts being expressed as dry matter and related to the sum of (a) and (b).

Another subject of the present invention is a method for preparing such a starch-based composition comprising the following steps:
(i) selection of at least one granular starch and of at least one organic plasticizer of this starch;
(ii) preparation of a plasticized starchy composition (a) by thermomechanical mixing of this granular starch and of this plasticizer;
(iii) incorporation, into this plasticized starchy composition (a) obtained in step (ii), of a non-starchy polymer (b) in an amount such that the plasticized starchy composition (a) represents at least 51% by weight and the non-starchy polymer (b) represents at most 49% by weight, these amounts being expressed as dry matter and related to the sum of (a) and (b); and
(iv) incorporation, into the composition thus obtained, of at least one coupling agent having a molecular weight of less than 5000, preferably of less than 1000, comprising at least two functional groups, at least one of which is capable of reacting with the plasticizer and at least one other of which is capable of reacting with the starch and/or the non-starchy polymer,
   the step (iii) possibly being carried out before, during or after step (iv).

The starch-based compositions obtained by this method contain the various ingredients, namely the starch, the plasticizer, the non-starchy polymer and the coupling agent, intimately mixed with one another. In these compositions, the coupling agent has, in principle, not yet reacted with the plasticizer that thus attaches it covalently to the starch and/or the non-starchy polymer. These compositions are then used to prepare compositions referred to hereinbelow as “thermoplastic starchy compositions”. In these thermoplastic starchy compositions, at least one portion of the coupling agent has reacted with the plasticizer and with the starch and/or the non-starchy polymer. It is this attachment of the plasticizer to one or the other or both components which gives the thermoplastic starchy compositions of the present invention the advantageous properties that are subsequently specified.

The applicant wishes simply to emphasize that, although the two types of compositions of the present invention (before and after reaction of the coupling agent) contain starch and have a thermoplastic nature, the compositions before reaction of the coupling agent will be referred to hereinbelow systematically as “starch-based compositions” whereas the compositions obtained by heating of the latter and that contain the reaction product of the plasticizer, of the coupling agent and of the starch and/or the non-starchy polymer will be referred to as “thermoplastic compositions” or “thermoplastic starchy compositions”.

Another subject of the present invention is therefore a method for preparing such a “thermoplastic starchy composition” comprising the heating of a starch-based composition, as defined above, to a sufficient temperature and for a sufficient duration in order to react the coupling agent, on the one hand, with the plasticizer and, on the other hand, with the starch of the plasticized starchy composition (a) and/or the non-starchy polymer (b), and also a thermoplastic starchy composition capable of being obtained by such a method.

Within the meaning of the invention, the expression “granular starch” is understood to mean a native starch or a physically, chemically or enzymatically modified starch that has retained, within the starch granules, a semicrystalline structure similar to that displayed in the starch grains naturally present in the reserve tissues and organs of higher plants, in particular in the seeds of cereal plants, the seeds of leguminous plants, potato or cassava tubers, roots, bulbs, stems and fruits. This semicrystalline state is essentially due to the macromolecules of amylopectin, one of the two main constituents of starch. In the native state, the starch grains have a degree of crystallinity which varies from 15 to 45%, and which essentially depends on the botanical origin of the starch and on the optional treatment that it has undergone. Granular starch, placed under polarized light, has, under a microscope, a characteristic black cross known as a “Maltese cross”, typical of the crystalline granular state. For a more detailed description of granular starch, reference could be made to chapter II entitled “Structure et morphologie du grain d'amidon” [Structure and morphology of the starch grain] by S. Perez, in the work “Initiation à la chimie et à la physico-chimie macromoléculaires” [Introduction to macromolecular chemistry and physical chemistry], first edition 2000, Volume 13, pages 41 to 86, Groupe Français d'Etudes et d'Application des Polymères [French Group of Polymer Studies and Applications].

The granular starch used for the preparation of the plasticized starchy composition (a) may come from any botanical origin. It may be native starch of cereal plants such as wheat, maize, barley, triticale, sorghum or rice, tubers such as potato or cassaya, or leguminous plants such as pea or soybean, and mixtures of such starches. According to one preferred variant, granular starch, of any botanical origin, is a starch modified by acid, oxidizing or enzymatic hydrolysis, or by oxidation. It may be, in particular, a starch commonly known as fluidized starch, an oxidized starch or a white dextrin. It may also be a starch modified by a physicochemical route, but that has essentially retained the structure of the initial native starch, such as, in particular, esterified and/or etherified starches, in particular that are modified by acetylation, hydroxypropylation, cationization, crosslinking, phosphation or succinylation, or starches treated in an aqueous medium at low temperature (“annealed” starches), treatment which is known to increase the crystallinity of the starch. It may finally be a starch modified by a combination of the treatments mentioned above or any mixture of these native starches, starches modified by hydrolysis, starches modified by oxidation and starches modified by a physicochemical route.

The granular starch used in the present invention has, before plasticization with the plasticizer, a solubles content at 20° C. in demineralized water of less than 5% by weight. It may be almost insoluble in cold water.

In one preferred embodiment, the granular starch is chosen from fluidized starches, oxidized starches, starches that have undergone a chemical modification, white dextrins or a mixture of these products.

The expression “plasticizer of the starch” is understood to mean any organic molecule of low molecular weight, that is to say having a molecular weight of less than 5000, in particular less than 1000, which, when it is incorporated into the starch via a thermomechanical treatment at a temperature between 20 and 200° C., results in a decrease of the glass transition temperature and/or a reduction of the crystallinity of a granular starch to a value of less than 15%, or even to an essentially amorphous state. This definition of the plasticizer does not encompass water. The applicant has observed that water, although it has a starch-plasticizing effect, has the major drawback of inactivating most of the functional groups capable of being present on the crosslinking agent, such as the isocyanate functional groups.

Mention may be made, as examples of plasticizers, of sugars such as glucose, maltose, fructose or saccharose; polyols such as ethylene glycol, propylene glycol, polyethylene glycols (PEGs), glycerol, sorbitol, xylitol, maltitol or hydrogenated glucose syrups; urea, salts of organic acids such as sodium lactate and also mixtures of these products.

The plasticizer of the starch is preferably chosen from diols, triols and polyols such as glycerol, polyglycerol, isosorbide, sorbitans, sorbitol, mannitol, and hydrogenated glucose syrups, the salts of organic acids such as sodium lactate, urea and mixtures of these products. The plasticizer advantageously has a molecular weight of less than 5000, preferably less than 1000, and in particular less than 400. The plasticizer has a molecular weight greater than that of water, namely greater than 18.

The plasticizer is incorporated into the granular starch preferably in an amount of 10 to 150 parts by dry weight, preferably in an amount of 25 to 120 parts by dry weight and in particular in an amount of 40 to 120 parts by dry weight per 100 parts by dry weight of granular starch.

The plasticized starchy composition (a) constituted of starch and of plasticizer, expressed in dry weight, preferably represents more than 51%, more preferably more than 55% and better still more than 60% by weight of dry matter of the sum of (a) and (b), this amount ideally being greater than 70% and may even attain 99.8%.

More particularly, the amount of plasticized starchy composition (a), expressed as dry matter and related to the sum of (a) and (b), is preferably between 51% and 99.8% by weight, better still between 55% and 99.5% by weight, and in particular between 60% and 99% by weight, the component (b), that is to say the non-starchy polymer, representing the complementary part up to 100% by weight.

This amount of plasticized starchy composition is preferably between 65% and 85% by weight.

Fillers and other additives, explained in detail hereinbelow, may be incorporated into the starch-based compositions of the present invention. Although the proportion of these additional ingredients can be quite high, the plasticized starchy composition (a) and the non-starchy polymer (b) represent, together, preferably at least 20% by weight, in particular at least 30% by weight and ideally at least 50% by weight of the starch-based compositions of the present invention.

The expression “coupling agent” is understood within the present invention to mean any organic molecule bearing at least two free or masked functional groups capable of reacting with molecules bearing functional groups having an active hydrogen such as starch or the plasticizer of the starch. As explained above, this coupling agent enables the attachment, via covalent bonds, of at least one part of the plasticizer to the starch and/or to the non-starchy polymer. The coupling agent therefore differs from adhesion agents, physical compatibilizing agents or grafting agents, described in the prior art, by the fact that the latter either only create weak bonds (non-covalent bonds), or only bear a single reactive functional group.

As indicated above, the molecular weight of the coupling agent used in the present invention is less than 5000 and preferably less than 1000. Indeed, the low molecular weight of the coupling agent favors its rapid diffusion into the plasticized starch composition.

Preferably, said coupling agent has a molecular weight between 50 and 500, in particular between 90 and 300.

The coupling agent may be chosen, for example, from compounds bearing at least two identical or different, free or masked, functional groups, chosen from isocyanate, carbamoylcaprolactam, epoxide, halogen, protonic acid, acid anhydride, acyl halide, oxychloride, trimetaphosphate, and alkoxysilane functional groups and combinations thereof.

It may advantageously be the following compounds:
diisocyanates and polyisocyanates, preferably 4,4′-dicyclohexylmethane diisocyanate (H12MDI), methylene diphenyl diisocyanate (MDI), toluene diisocyanate (TDI), naphthalene diisocyanate (NDI), hexamethylene diisocyanate (HMDI) and lysine diisocyanate (LDI);
dicarbamoylcaprolactams, preferably 1,1′-carbonylbiscaprolactam;
diepoxides;
halohydrins, that is to say compounds comprising an epoxide functional group and a halogen functional group, preferably epichlorohydrin;
organic diacids, preferably succinic acid, adipic acid, glutaric acid, oxalic acid, malonic acid, maleic acid and the corresponding anhydrides;
oxychlorides, preferably phosphorus oxychloride;
trimetaphosphates, preferably sodium trimetaphosphate;
alkoxysilanes, preferably tetraethoxysilane,
   and any mixtures of these compounds.

In one preferred embodiment of the present invention, the coupling agent is chosen from organic diacids and compounds bearing at least two identical or different, free or masked functional groups chosen from isocyanate, carbamoylcaprolactam, epoxide, halogen, acid anhydride, acyl halide, oxychloride, trimetaphosphate and alkoxysilane functional groups.

In one preferred embodiment of the method of the invention, the coupling agent is chosen from diepoxides, diisocyanates and halohydrins. In particular, it is preferred to use a coupling agent chosen from diisocyanates, methylene diphenyl diisocyanate (MDI) and 4,4′-dicyclohexylmethane diisocyanate (H12MDI) being particularly preferred.

The amount of coupling agent, expressed as dry matter and related to the sum of the plasticized starchy composition (a) and of the non-starchy polymer (b), is advantageously between 0.1 and 15% by weight, preferably between 0.1 and 12% by weight, better still between 0.2 and 9% by weight and in particular between 0.5 and 5% by weight.

By way of example, this amount of coupling agent may be between 0.5 and 3% by weight.

The use of diisocyanates in the presence of starch has, certainly, already been described but under conditions and for purposes very different from those of the present invention.

Indeed, bringing together granular starch and diisocyanates is known and described in the literature, but always in the absence of plasticizer of the starch, for the purposes of enabling:
a functionalization of the granular starch by grafting of monofunctional units based on isocyanates and, for example, a monoalcohol or a monoamine;
a compatibilization of dry granular starch with a hydrophobic matrix, such as PLA, PBS, PCL or polyurethane;
or a preparation of starch-based polyurethane foams.

The article entitled “Effect of Compatibilizer Distribution on the Blends of Starch/Biodegradable Polyesters” by Long Yu et al., Journal of Applied Polymer Science, Vol. 103, 812-818 (2007), 2006, Wiley Periodicals Inc., describes the effect of methylene diphenyl diisocyanate (MDI) as a compatibilizing agent of mixtures of a starch gelatinized with water (70% starch, 30% water) and of a biodegradable polyester (PCL or PBSA), which are known for being immiscible with one another from a thermodynamic viewpoint. This document does not at any moment envisage the use of an organic plasticizer, capable of replacing the water which has the drawback of deactivating the isocyanate functional groups of MDI used and of not allowing a thermoplastic starchy composition of sufficient flexibility to be obtained, probably due to the evaporation of the water on exiting the thermomechanical treatment device or during storage.

The article entitled “Effects of Starch Moisture on Properties on Wheat Starch/Poly(Lactic Acid) Blend Containing Methylenediphenyl Diisocyanate”, by Wang et al., published in Journal of Polymers and the Environment, Vol. 10, No. 4, October 2002, also relates to the compatibilization of a starch solution and of a polylactic acid (PLA) phase by the addition of methylene diphenyl isocyanate (MDI). As in the preceding article, water is the only plasticizer envisaged but has, as pointed out previously, the drawbacks indicated above.

The article entitled “Thermal and Mechanical Properties of Poly(lactic acid)/Starch/Methylenediphenyl Diisocyanate Blending with Triethyl Citrate” by Ke et al., Journal of Applied Polymer Science, Vol. 88, 2947-2955 (2003) relates, like the above two articles, to the problem of the thermodynamic incompatibility of starch and PLA. This document studies the effect of the use of triethyl citrate, as a plasticizer in starch/PLA/MDI mixtures. However, it clearly emerges from this document (see page 2952, left-hand column, Morphology) that triethyl citrate plays the role of plasticizer only for the PLA phase but not for the starchy phase which remains in the form of starch granules dispersed in a PLA matrix plasticized by the triethyl citrate. Furthermore, the starch fraction of the compositions disclosed in this document does not exceed 45% by weight.

International Application WO 01/48078 describes a method for preparing thermoplastics by incorporating a synthetic polymer in the melt state into thermoplastic compositions. This document envisages, certainly, the use of a plasticizer of polyol type, but does not at any moment mention the possibility of attaching the plasticizer to the starch and/or the synthetic polymer via a low molecular weight coupling agent.

The article entitled “The influence of citric acid on the properties of thermoplastic starch/linear low-density polyethylene blends” by Ning et al., in Carbohydrate Polymers, 67, (2007), 446-453 studies the effect of the presence of citric acid on thermoplastic starch/polyethylene mixtures. This document does not at any moment envisage the attachment of the plasticizer used (glycerol) to the starch or the polyethylene via a bifunctional or polyfunctional compound. The spectroscopy results presented in this document do not display any covalent bond between the citric acid and the starch or the glycerol. It is simply observed that the physical bonds (hydrogen bonds) between the starch and the glycerol are strengthened by the presence of citric acid.

In conclusion, none of the above documents describes nor suggests a thermoplastic composition similar to that of the present invention comprising a reactive, at least bifunctional, coupling agent in a composition containing at least 51% by weight of a plasticized starchy composition and at most 49% by weight of a non-starchy polymer.

In one embodiment of the present invention, the plasticized starchy composition (a) described above may be partially replaced by a starch that is soluble in water or organic solvents.

Within the meaning of the invention, the expression “soluble starch” is understood to mean any starch-derived polysaccharidic material having, at 20° C., a fraction that is soluble in a solvent chosen from demineralized water, ethyl acetate, propyl acetate, butyl acetate, diethyl carbonate, propylene carbonate, dimethyl glutarate, triethyl citrate, dibasic esters, dimethyl sulfoxide (DMSO), dimethyl isosorbide, glyceryl triacetate, isosorbide diacetate, isosorbide dioleate and the methyl esters of plant oils, at least equal to 5% by weight. This soluble fraction is preferably greater than 20% by weight and in particular greater than 50% by weight. Of course, the soluble starch may be completely soluble in one or more of the solvents indicated above (soluble fraction=100%).

In the case of the partial replacement of the plasticized starchy composition (a), the soluble starch is used in solid, preferably essentially anhydrous form, that is to say it is not dissolved in an aqueous or organic solvent. It is therefore important not to confuse, throughout the description that follows, the term “soluble” with the term “dissolved”.

Such soluble starches may be obtained by pre-gelatinization on a drum, spray drying, hydrothermal cooking, chemical functionalization or other. It may in particular be a pregelatinized starch, a highly converted dextrin (also known as yellow dextrin), a maltodextrin, a highly functionalized starch or a mixture of these starches.

The pregelatinized starches may be obtained by hydrothermal treatment for gelatinization of native starches or of modified starches, in particular by steam cooking, jet-cooker cooking, cooking on drums, cooking in kneader-extruder systems then drying, for example in an oven, with hot air over a fluidized bed, on rotating drums, by spray drying, by extrusion or by freeze drying. Such starches usually have a solubility in demineralized water at 20° C. that is greater than 5% and more generally between 10 and 100%. By way of example, mention may be made of the products manufactured and sold by the applicant under the trade mark PREGEFLO®.

The highly converted dextrins may be prepared from native or modified starches, by dextrinification in a barely hydrated acid medium. They may be, in particular, soluble white dextrins or yellow dextrins. By way of example, mention may be made of the products STABILYS® A 053 or TACKIDEX® C072 manufactured and sold by the applicant. Such dextrins have, in demineralized water at 20° C., a solubility usually between 10 and 95%.

Maltodextrins may be obtained by acid, oxidizing or enzymatic hydrolysis of starches in an aqueous medium. They may have, in particular, a dextrose equivalent between 0.5 and 40, preferably between 0.5 and 20 and better still between 0.5 and 12. Such maltodextrins are, for example, manufactured and sold by the applicant under the trade name GLUCIDEX® and have, in demineralized water at 20° C., a solubility generally greater than 90%, or even close to 100%.

The highly functionalized starches may be obtained from a native or modified starch. The high functionalization may, for example, be carried out by esterification or etherification at a sufficiently high level to give it a solubility in water or in one of the organic solvents above. Such functionalized starches have a soluble fraction as defined above, greater than 5%, preferably greater than 10%, better still greater than 50%.

The high functionalization may be obtained, in particular, by acetylation in an acetic anhydride and acetic acid solvent phase, grafting by use, for example, of acid anhydrides, mixed anhydrides, fatty acid chlorides, oligomers of caprolactones or lactides, hydroxypropylation in the adhesive phase, cationization in the dry phase or adhesive phase, anionization in the dry phase or adhesive phase by phosphation or succinylation. These highly functionalized starches may be water-soluble and then have a degree of substitution between 0.1 and 3, and better still between 0.25 and 3.

In the case of organosoluble highly functionalized starches, such as acetates of starch, of dextrin or of maltodextrin, the degree of substitution is usually higher and greater than 0.1, better between 0.2 and 3, better still between 0.80 and 2.80 and ideally between 1.5 and 2.7. Preferably, the reactants for modification or for functionalization of the starch are of renewable origin.

Preferably, the reactants for modification or for functionalization of the starch are of renewable origin.

Preferably, the soluble starch is a derivative of natural or modified wheat or pea starches.

Preferably, the soluble starch has a low water content, generally of less than 10%, preferably less than 5%, in particular less than 2% by weight and ideally less than 0.5%, or even less than 0.2% by weight.

The non-starchy polymer may be a polymer of natural origin, or else a synthetic polymer obtained from monomers of fossil origin and/or monomers derived from renewable natural resources.

The non-starchy polymer advantageously comprises functional groups having an active hydrogen and/or functional groups which give, especially via hydrolysis, such functional groups having an active hydrogen.

The polymers of natural origin may be obtained by extraction from plants or animal tissues. They are preferably modified or functionalized, and are in particular of protein, cellulose, lignocellulose, chitosan and natural rubber type. It is also possible to use polymers obtained by extraction from cells of microorganisms, such as polyhydroxyalkanoates (PHAs).

Such a polymer of natural origin may be chosen from flours, modified or unmodified proteins, celluloses that are unmodified or that are modified, for example, by carboxymethylation, ethoxylation, hydroxypropylation, cationization, acetylation or alkylation, hemi-celluloses, lignins, modified or unmodified guars, chitins and chitosans, natural resins and gums such as natural rubbers, rosins, shellacs and terpene resins, polysaccharides extracted from algae such as alginates and carrageenans, polysaccharides of bacterial origin such as xanthans or PHAs, lignocellulosic fibers such as flax fibers.

The synthetic non-starchy polymer obtained from monomers of fossil origin, preferably comprising functional groups having active hydrogen, may be chosen from synthetic polymers of polyester, polyacrylic, polyacetal, polycarbonate, polyamide, polyimide, polyurethane, polyolefin, functionalized polyolefin, styrene, functionalized styrene, vinyl, functionalized vinyl, functionalized fluoro, functionalized polysulfone, functionalized polyphenyl ether, functionalized polyphenyl sulfide, functionalized silicone and functionalized polyether type.

By way of example, mention may be made of PLAs, PBSs, PBSAs, PBATs, PETs, polyamides PA-6, PA-6,6, PA-6,10, PA-6,12, PA-11 and PA-12, copolyamides, polyacrylates, polyvinyl alcohol, polyvinyl acetates, ethylene/vinyl acetate copolymers (EVAs), ethylene/methyl acrylate copolymers (EMAs), ethylene/vinyl alcohol copolymers (EVOHs), polyoxymethylenes (POMs), acrylonitrile-styrene-acrylate copolymers (ASAs), thermoplastic polyurethanes (TPUs), polyethylenes or polypropylenes that are functionalized, for example, by silane, acrylic or maleic anhydride units and styrene-butylene-styrene (SBS) and styrene-ethylene-butylene-styrene (SEBS) copolymers, preferably functionalized, for example, with maleic anhydride units and any mixtures of these polymers.

The non-starchy polymer may also be a polymer synthesized from monomers derived from short-term renewable natural resources such as plants, microorganisms or gases, especially from sugars, glycerol, oils or derivatives thereof such as alcohols or acids, which are monofunctional, difunctional or polyfunctional, and in particular from molecules such as bio-ethanol, bio-ethylene glycol, bio-propanediol, biosourced 1,3-propanediol, bio-butanediol, lactic acid, biosourced succinic acid, glycerol, isosorbide, sorbitol, saccharose, diols derived from plant oils or animal oils and resinic acids extracted from pine.

It may especially be polyethylene derived from bio-ethanol, polypropylene derived from bio-propanediol, polyesters of PLA or PBS type based on biosourced lactic acid or succinic acid, polyesters of PBAT type based on biosourced butanediol or succinic acid, polyesters of SORONA® type based on biosourced 1,3-propanediol, polycarbonates containing isosorbide, polyethylene glycols based on bio-ethylene glycol, polyamides based on castor oil or on plant polyols, and polyurethanes based, for example, on plant diols, glycerol, isosorbide, sorbitol or saccharose.

Preferably, the non-starchy polymer is chosen from ethylene/vinyl acetate copolymers (EVAs), polyethylenes (PEs) and polypropylenes (PPs) that are unfunctionalized or functionalized, in particular, with silane units, acrylic units or maleic anhydride units, thermoplastic polyurethanes (TPUs), polybutylene succinates (PBSs), polybutylene succinate-co-adipates (PBSAs), polybutylene adipate terephthalates (PBATs), styrene-butylene-styrene and styrene-ethylene-butylene-styrene (SEBSs) copolymers, preferably that are functionalized, in particular with maleic anhydride units, amorphous polyethylene terephthalates (PETGs), synthetic polymers obtained from biosourced monomers, polymers extracted from plants, from animal tissues and from microorganisms, which are optionally functionalized, and mixtures thereof.

Mention may be made, as examples of particularly preferred non-starchy polymers, of polyethylenes (PEs) and polypropylenes (PPs), preferably that are functionalized, styrene-ethylene-butylene-styrene copolymers (SEBSs), preferably that are functionalized, amorphous polyethylene terephthalates (PETGs) and thermoplastic polyurethanes.

Advantageously, the non-starchy polymer has a weight-average molecular weight between 8500 and 10 000 000 daltons, in particular between 15 000 and 1 000 000 daltons.

Furthermore, the non-starchy polymer is preferably constituted of carbon of renewable origin within the meaning of ASTM D6852 standard and is advantageously not biodegradable or not compostable within the meaning of the EN 13432, ASTM D6400 and ASTM 6868 standards.

The incorporation of the plasticizer in the granular starch via thermomechanical mixing (step (ii)) is carried out by hot kneading at a temperature preferably between 60 and 200° C., more preferably between 100 and 160° C., in a batchwise manner, for example by dough mixing/kneading, or continuously, for example by extrusion. The duration of this mixing may range from a few seconds to a few hours, depending on the mixing method used.

The incorporation of the non-starchy polymer (b) into the plasticized starchy composition (a) (step (iii)) is preferably carried out by hot kneading at a temperature between 60 and 200° C., and better still from 100 to 160° C. This incorporation may be carried out by thermomechanical mixing, in a batchwise manner or continuously and in particular in-line. In this case, the mixing time may be short, from a few seconds to a few minutes.

The incorporation of the coupling agent into the mixture of the plasticized starchy composition (a) and of the non-starchy polymer (b) is preferably carried out by hot kneading at a temperature between 60 and 200° C., and better still from 100 to 160° C. This incorporation may be carried out by thermomechanical mixing, in a batchwise manner or continuously and in particular in-line. In this case, the mixing time may be short, from a few seconds to a few minutes.

In one preferred embodiment, the method of the present invention also comprises the drying or the dehydration of the composition obtained in step (iii), before the incorporation of the coupling agent, to a residual moisture content of less than 5%, preferably less than 1%, and in particular less than 0.1%.

Depending on the amount of water to be eliminated, this drying step may be carried out in batches or continuously during the method.

As explained in the introduction, another subject of the present invention is thermoplastic starchy compositions obtained by heating of the above starch-based compositions, at a sufficient temperature and for a sufficient time in order to react the coupling agent with the plasticizer and with the starch and/or the non-starchy polymer.

This heating is advantageously carried out at a temperature between 100 and 200° C., and better still between 130 to 180° C. This heating may be carried out by thermomechanical mixing, in a batchwise manner or continuously and in particular in-line. In this case, the mixing time may be short, from a few seconds to a few minutes.

The two types of compositions of the present invention (before and after reaction of the coupling agent) preferably have a structure of “solid dispersion” type.

In other words, the compositions of the present invention, despite their high starch content, contain this plasticized starch in the form of domains dispersed in a continuous polymer matrix. This dispersion type structure should be distinguished, in particular, from a structure where the plasticized starch and the non-starchy polymer only constitute one and the same phase, or else compositions containing two co-continuous networks of plasticized starch and of non-starchy polymer. The objective of the present invention is not in fact so much preparing biodegradable materials as obtaining plastics with a high starch content that have excellent rheological and mechanical properties.

Within the context of its research, the applicant has observed that, against all expectation, very small amounts of coupling agent made it possible to considerably reduce the sensitivity to water and to steam of the final thermoplastic starchy composition obtained, and made it possible, in particular, to cool this composition rapidly at the end of manufacture by immersion in water, which is impossible for the plasticized starches of the prior art, prepared by simple mixing with the plasticizer, that is to say without attachment of the plasticizer to the starch and/or to the non-starchy polymer. These starches, due to their high sensitivity to water, must necessarily be cooled in air, which requires much more time than cooling in water. Furthermore, this characteristic of stability to water opens up many new potential uses for the composition according to the invention.

The applicant has also observed that the starch-based thermoplastic compositions prepared according to the invention exhibited less thermal degradation and less coloration than the plasticized starches of the prior art.

The final thermoplastic starchy composition has a complex viscosity, measured on a rheometer of PHYSICA MCR 501 type or equivalent, between 10 and 106 Pa·s, for a temperature between 100 and 200° C. In view of its implementation by injection molding for example, its viscosity at these temperatures is preferably situated in the lower part of this range and the composition is then preferably thermofusible within the meaning specified above.

These thermoplastic compositions according to the invention have the advantage of being not very soluble or even completely insoluble in water, of hydrating with difficulty and of retaining good physical integrity after immersion in water. Their insolubles content after 24 hours in water at 20° C. is preferably greater than 72%, in particular greater than 80%, better still greater than 90%. Very advantageously, it may be greater than 92%, especially greater than 95%. Ideally, this insolubles content may be at least equal to 98% and especially be close to 100%.

Furthermore, the degree of swelling of the thermoplastic compositions according to the invention, after immersion in water at 20° C. for a duration of 24 hours, is preferably less than 20%, in particular less than 12%, better still less than 6%. Very advantageously, it may be less than 5%, especially less than 3%. Ideally, this degree of swelling is at most equal to 2% and may especially be close to 0%.

Unlike the compositions of the prior art with high contents of thermoplastic starch, the composition according to the invention advantageously has stress/strain curves that are characteristic of a ductile material, and not of a brittle material. The elongation at break, measured for the compositions of the present invention, is greater than 40%, preferably greater than 80%, better still greater than 90%. This elongation at break may advantageously be at least equal to 95%, especially at least equal to 120%. It may even attain or exceed 180%, or even 250%. In general, it is reasonably below 500%.

The maximum tensile strength of the compositions of the present invention is generally greater than 4 MPa, preferably greater than 6 MPa, better still greater than 8 MPa. It may even attain or exceed 10 MPa, or even 20 MPa. In general, it is reasonably below 80 MPa.

The composition according to the invention may also comprise various other additional products. These may be products that aim to improve its physicochemical properties, in particular its processing behavior and its durability or else its mechanical, thermal, conductive, adhesive or organoleptic properties.

The additional product may be an agent that improves or adjusts mechanical or thermal properties chosen from minerals, salts and organic substances, in particular from nucleating agents such as talc, compatibilizing agents such as surfactants, agents that improve the impact strength or scratch resistance such as calcium silicate, shrinkage control agents such as magnesium silicate, agents that trap or deactivate water, acids, catalysts, metals, oxygen, infrared radiation or UV radiation, hydrophobic agents such as oils and fats, hygroscopic agents such as pentaerythritol, flame retardants and fire retardants such as halogenated derivatives, anti-smoke agents, mineral or organic reinforcing fillers, such as clays, carbon black, talc, plant fibers, glass fibers or kevlar.

The additional product may also be an agent that improves or adjusts conductive or insulating properties with respect to electricity or heat, impermeability for example to air, water, gases, solvents, fatty substances, gasolines, aromas and fragrances, chosen, in particular, from minerals, salts and organic substances, in particular from nucleating agents such as talc, compatibilizing agents such as surfactants, agents which trap or deactivate water, acids, catalysts, metals, oxygen or infrared radiation, hydrophobic agents such as oils and fats, beading agents, hygroscopic agents such as pentaerythritol, agents for conducting or dissipating heat such as metallic powders, graphites and salts, and micrometric reinforcing fillers such as clays and carbon black.

The additional product may also be an agent that improves organoleptic properties, in particular:
odorant properties (fragrances or odor-masking agents);
optical properties (brighteners, whiteners, such as titanium dioxide, dyes, pigments, dye enhancers, opacifiers, mattifying agents such as calcium carbonate, thermochromic agents, phosphorescence and fluorescence agents, metallizing or marbling agents and antifogging agents);
sound properties (barium sulfate and barytes); and
tactile properties (fatty substances).

The additional product may also be an agent that improves or adjusts adhesive properties, especially adhesion with respect to cellulose materials such as paper or wood, metallic materials such as aluminum and steel, glass or ceramic materials, textile materials and mineral materials, especially pine resins, rosin, ethylene/vinyl alcohol copolymers, fatty amines, lubricants, demolding agents, antistatic agents and antiblocking agents.

Finally, the additional product may be an agent that improves the durability of the material or an agent that controls its (bio)degradability, especially chosen from hydrophobic agents such as oils and fats, anticorrosion agents, antimicrobial agents such as Ag, Cu and Zn, degradation catalysts such as oxo catalysts and enzymes such as amylases.

The thermoplastic composition of the present invention also has the advantage of being constituted of essentially renewable raw materials and of being able to exhibit, after adjustment of the formulation, the following properties, that are of use in multiple plastics processing applications or in other fields:
suitable thermoplasticity, melt viscosity and glass transition temperature, within the standard value ranges known for common polymers (T_{g} of from −50° to 150° C.), allowing implementation by virtue of existing industrial installations that are conventionally used for standard synthetic polymers;
sufficient miscibility with a wide variety of polymers of fossil origin or of renewable origin that are on the market or in development;
satisfactory physicochemical stability for the usage conditions;
low sensitivity to water and to steam;
mechanical performances that are very significantly improved compared to the thermoplastic starch compositions of the prior art (flexibility, elongation at break, maximum tensile strength);
good barrier effect to water, to steam, to oxygen, to carbon dioxide, to UV radiation, to fatty substances, to aromas, to gasolines, to fuels;
opacity, translucency or transparency that can be adjusted as a function of the uses;
good printability and ability to be painted, especially by aqueous-phase inks and paints;
controllable shrinkage;
stability over sufficient time; and
good recyclability.

Quite remarkably, the thermoplastic starchy composition of the present invention may, in particular, simultaneously have:
an insolubles content at least equal to 98%;
a degree of swelling of less than 5%;
an elongation at break at least equal to 95%; and
a maximum tensile strength of greater than 8 MPa.

The thermoplastic starchy composition according to the invention may be used as is or as a blend with synthetic polymers, artificial polymers or polymers of natural origin. It may be biodegradable or compostable within the meaning of the EN 13432, ASTM D6400 and ASTM 6868 standards, and then comprise polymers or materials corresponding to these standards, such as PLA, PCL, PBSA, PBAT and PHA.

It may in particular make it possible to correct certain major defects that are known for PLA, namely:
the mediocre barrier effect to CO₂ and to oxygen;
the inadequate barrier effects to water and to steam;
the inadequate heat resistance for the manufacture of bottles and the very inadequate heat resistance for the use as textile fibers; and
a brittleness and lack of flexibility in the form of films.

The composition according to the invention is however preferably not biodegradable or not compostable within the meaning of the above standards, and then comprises, for example, known synthetic polymers or starches or extracted polymers that are highly functionalized, crosslinked or etherified.

The best performances in terms of rheological, mechanical and water-insensitivity properties have in fact been obtained with such non-biodegradable and non-compostable compositions.

It is possible to adjust the service life and the stability of the composition in accordance with the invention by adjusting, in particular, its affinity for water, so as to be suitable for the expected uses as material and for the methods of reuse envisaged at the end of life.

The starch-based composition and the thermoplastic starchy composition of the present invention advantageously contain at least 33%, preferably at least 50%, in particular at least 60%, better still at least 70%, or even more than 80% of carbon of renewable origin within the meaning of ASTM D6852 standard. This carbon of renewable origin is essentially that constituent of the starch inevitably present in the composition according to the invention but may also advantageously, via a judicious choice of the constituents of the composition, be that present in the plasticizer of the starch as in the case, for example, of glycerol or sorbitol, but also of that present in the polymer(s) of the non-starchy matrix or any other constituent of the thermoplastic composition, when they originate from renewable natural resources such as those preferentially defined above.

In particular, it can be envisaged to use the starch-based thermoplastic compositions according to the invention as barrier films to water, to steam, to oxygen, to carbon dioxide, to aromas, to fuels, to automotive fluids, to organic solvents and/or to fatty substances, alone or in multilayer or multiply structures, obtained by coextrusion, lamination or other techniques, for the field of food packaging, the field of printing supports, the insulation field or the textile field in particular.

The compositions of the present invention may also be used to increase the hydrophilic nature, the aptitude for electrical conduction or for microwaves, the printability, the ability to be dyed, to be colored in the bulk or to be painted, the antistatic or antidust effect, the scratch resistance, the fire resistance, the adhesive strength, the ability to be heat-welded, the sensory properties, in particular the feel and the acoustic properties, the water and/or steam permeability, or the resistance to organic solvents and/or fuels, of synthetic polymers within the context, for example, of the manufacture of membranes, of films for printable electronic labels, of textile fibers, of containers or tanks, or synthetic thermofusible films, of parts obtained by injection molding or extrusion such as parts for motor vehicles.

It should be noted that the relatively hydrophilic nature of the thermoplastic composition according to the invention considerably reduces the risks of bioaccumulation in the adipose tissues of living organisms and therefore also in the food chain.

The composition according to the invention may be in pulverulent form, granular form or in the form of beads and may constitute the matrix of a masterbatch that can be diluted in a biosourced or non-biosourced matrix.

The invention also relates to a plastic or elastomeric material comprising the thermoplastic composition of the present invention or a finished or semi-finished product obtained from this composition.

### EXAMPLE

### Composition According to the Prior Art and Compositions According to the Invention Obtained with Wheat Starch, a Starch Plasticizer, a Silane-Grafted PE and a Coupling Agent

### Preparation of the Compositions:

Used for this example are:
as granular starch, a native wheat starch sold by the applicant under the name “Amidon de blé SP” [Wheat Starch SP] having a water content of around 12%;
as plasticizer of the granular starch, a concentrated aqueous composition of polyols based on glycerol and on sorbitol, sold by the applicant under the name POLYSORB G84/41/00 having a water content of approximately 16%;
as non-starchy polymer, a polyethylene grafted with 2% of vinyltrimethoxysilane (PEgSi). This PEgSi used was obtained beforehand by grafting vinyltrimethoxysilane to a low-density PE via extrusion. Mention may be made, as an example of such a PEgSi that is available on the market, of the product Bor PEX ME2510 or Bor PEX HE2515 both sold by Borealis; and
as coupling agent, methylene diphenyl diisocyanate (MDI) sold under the name Suprasec 1400 by Huntsman.

Firstly, for comparison purposes, a thermoplastic composition according to the prior art is prepared. For this, a twin-screw extruder of TSA brand having a diameter (D) of 26 mm and a length of 56D is fed with the starch and the plasticizer so as to obtain a total material throughput of 15 kg/h, with a mixing ratio of 67 parts of POLYSORB® plasticizer per 100 parts of wheat starch.

The extrusion conditions are the following:
temperature profile (ten heating zones Z1 to Z10): 90/90/110/140/140/110/90/90/90/90;
screw speed: 200 rpm.

At the outlet of the extruder, it is observed that the material thus obtained is too tacky to be granulated in equipment commonly used for standard synthetic polymers. It is also observed that the composition is too water-sensitive to be cooled in a tank of cold water as is carried out for synthetic polymers of fossil origin. For these reasons, the plasticized starch rods are cooled in air on a conveyor belt in order to then be dried at 80° C. in an oven under vacuum for 24 hours before being granulated.

The composition thus obtained after drying is named “Composition AP6040”.

For the purpose of increasing the water stability of the base composition AP6040 obtained in the manner described above, the granules are mixed with various amounts of MDI and of polyethylene grafted with 2% vinyltrimethoxysilane (PEgSi), thus forming a dry blend.

The twin-screw extruder described previously is fed with this dry blend.

The extrusion conditions are the following:
temperature profile (ten heating zones Z1 to Z10): 150° C.;
screw speed: 400 rpm.

### Water Stability Test:

The sensitivity to water and to moisture of the compositions prepared and the tendency of the plasticizer to migrate to the water and to therefore induce a degradation of the structure of the material is evaluated.

The content of insolubles in water of the compositions obtained is determined according to the following protocol:
(i) drying the sample to be characterized (12 hours at 80° C. under vacuum);
(ii) measuring the mass of the sample (=Ms1) with a precision balance;
(iii) immersing the sample in water, at 20° C. (volume of water in ml equal to 100 times the mass in g of sample);
(iv) removing the sample after a defined time of several hours;
(v) removing the excess water at the surface with absorbent paper, as rapidly as possible;
(vi) placing the sample on a precision balance and monitoring the loss of mass over 2 minutes (measuring the mass every 20 seconds);
(vii) determining the mass of the swollen sample via graphical representation of the preceding measurements as a function of the time and extrapolation to t=0 of the mass (=Mg);
(viii) drying the sample (for 24 hours at 80° C. under vacuum). Measuring the mass of the dry sample (=Ms2);
(ix) calculating the insolubles content, expressed in percent, according to the equation Ms2/Ms1; and
(x) calculating the degree of swelling, in percent, according to the equation (Mg−Ms1)/Ms1.

TABLE 1
Degree of swelling and content of insolubles in water of the
thermoplastic compositions prepared with or without MDI

| | PEgSi/AP6040 | MDI | Cooling with | Degree of | |
|---|---|---|---|---|---|
| Test | ratio | (pcr) | water* | swelling** | Insolubles** |
| 07641 | 30/70 | 0 | 0 | broken up | not |
| | | | | | measurable |
| | | | | | (very low) |
| 07643 | 30/70 | 2 | 2 | 11 | 93 |
| 07644 | 10/90 | 4 | 1 | 35 | 60 |
| 07734 | 49/51 | 2 | 2 | 1.5 (2.7) | 100 (99.3) |
| 07735 | 40/60 | 2 | 2 | 3.5 (6.9) | 100 (98.0) |

*0 = impossible, 1 = possible, but sticky surface, 2 = possible without problem (hydrophobic)
**After 24 (72) hours in water at 20° C.

### Measurement of the Mechanical Properties:

The mechanical properties in tension of the various samples are determined according to the NF T51-034 standard (determination of the tensile properties) using a Lloyd Instruments LR5K test bench, a pull rate of 50 mm/min and standardized test specimens of H2 type.

From tensile curves (stress=f(elongation)), obtained at a pull rate of 50 mm/min, the elongation at break and the corresponding maximum tensile strength are obtained for each of the silane-grafted PE/AP6040 blends.

TABLE 2
Mechanical properties of the thermoplastic compositions
prepared with or without MDI (Table 1)

| Test | Elongation at break | Maximum tensile strength |
|---|---|---|
| 07641 | 128% | 1.4 MPa |
| (comparative) | | |
| 07643 | 198% | 6.7 MPa |
| (invention) | | |
| 07644 | 245% | 4.5 MPa |
| (invention) | | |
| 07734 | 97% | 10.5 MPa |
| (invention) | | |
| 07735 | 123% | 8.3 MPa |
| (invention) | | |

It appears that the mixture 07641 containing 30% of silane-grafted PE, produced without coupling agent (MDI), is very hydrophilic and cannot consequently be cooled in water on exiting the die since it breaks up very rapidly via hydration in the cooling bath.

All the blends according to the invention with plasticized starch/PEgSi prepared with a coupling agent (MDI), even those containing less than 30% of PEgSi, are only slightly hydrophilic and can advantageously be cooled without difficulty in water. Above 30%, the blends produced with MDI are very hydrophobic.

The mechanical properties of the compositions prepared with MDI are furthermore good to very good in terms of elongation at break and tensile strength.

The MDI, by bonding the plasticizer to the macromolecules of starch and of PEgSi, makes it possible to greatly improve the water resistance and mechanical strength properties, thus opening up multiple possible new uses for the compositions according to the invention compared to those of the prior art.

Analysis by mass spectrometry showed that the thermoplastic compositions thus prepared with use of a coupling agent such as MDI, contain specific entities of glucose-MDI-glycerol and glucose-MDI-sorbitol type, attesting to the attachment of the plasticizer to the starch via the coupling agent.

Moreover, observations by optical microscopy and scanning electron microscopy show that the compositions thus prepared according to the invention are in the form of dispersions of starch in a continuous polymer matrix of PEgSi.

All the thermoplastic compositions according to the present invention additionally have good scratch resistance and a “leather” feel. They can therefore find, for example, an application as a coating for fabrics, for wood panels, for paper or board.

1. A starch-based composition comprising:
(a) at least 51% by weight of a plasticized starchy composition constituted of starch and of an organic plasticizer thereof, obtained by thermomechanical mixing of granular starch and of a plasticizer thereof;
(b) at most 49% by weight of at least one non-starchy polymer; and
(c) a coupling agent having a molecular weight of less than 5000, preferably less than 1000, comprising at least two functional groups, of which at least one is capable of reacting with the plasticizer and at least one other is capable of reacting with the starch and/or the non-starchy polymer,
these amounts being expressed as dry matter and related to the sum of (a) and (b).

2. The composition as claimed in claim 1, characterized in that the granular starch is chosen from native starches, starches that have undergone acid, oxidizing or enzymatic hydrolysis, an oxidation or a chemical modification, especially an acetylation, hydroxypropylation, cationization, crosslinking, phosphation or succinylation, starches treated in an aqueous medium at low temperature (“annealed” starches) and mixtures of these starches.

3. The composition as claimed in claim 1, characterized in that the granular starch is chosen from fluidized starches, oxidized starches, starches that have undergone a chemical modification, white dextrins and mixtures of these products.

4. The composition as claimed in claim 1, characterized in that the plasticized starchy composition (a) is partially replaced by a starch that is soluble in water or organic solvents or a starch derivative that is soluble in water or organic solvents.

5. The composition as claimed in claim 4, characterized by the fact that the soluble starch or the soluble starch derivative is chosen from pregelatinized starches, highly converted dextrins, maltodextrins, highly functionalized starches and mixtures of these products.

6. The composition as claimed in claim 1, characterized by the fact that the plasticizer is chosen from glycerol, polyglycerols, isosorbide, sorbitans, sorbitol, mannitol, hydrogenated glucose syrups, sodium lactate, and mixtures of these products.

7. The composition as claimed in claim 1, characterized by the fact that the weight ratio of the plasticizer to the starch is between 10/100 and 150/100, preferably between 25/100 and 120/100.

8. The composition as claimed in claim 1, characterized in that the amount of the plasticized starchy composition (a), expressed as dry matter and related to the sum of (a) and (b), is between 51% and 99.8% by weight, preferably between 55% and 99.5% by weight, and in particular between 60% and 99% by weight.

9. The composition as claimed in claim 1, characterized in that the coupling agent is chosen from compounds bearing at least two identical or different, free or masked, functional groups, chosen from isocyanate, carbamoylcaprolactam, epoxide, halogen, protonic acid, acid anhydride, acyl halide, oxychloride, trimetaphosphate and alkoxysilane functional groups and mixtures thereof.

10. The composition as claimed in claim 9, characterized by the fact that the coupling agent is chosen from the following compounds:
diisocyanates and polyisocyanates, preferably 4,4′-dicyclohexylmethane diisocyanate (H12MDI), methylene diphenyl diisocyanate (MDI), toluene diisocyanate (TDI), naphthalene diisocyanate (NDI), hexamethylene diisocyanate (HMDI) and lysine diisocyanate (LDI);
dicarbamoylcaprolactams, preferably 1,1′-carbonylbiscaprolactam;
diepoxides;
halohydrins, preferably epichlorohydrin;
organic diacids, preferably succinic acid, adipic acid, glutaric acid, oxalic acid, malonic acid, maleic acid and the corresponding anhydrides;
oxychlorides, preferably phosphorus oxychloride;
trimetaphosphates, preferably sodium trimetaphosphate;
alkoxysilanes, preferably tetraethoxysilane,
and any mixtures of these compounds.

11. The composition as claimed in claim 10, characterized in that the coupling agent is a diisocyanate, preferably methylene diphenyl diisocyanate or 4,4′-dicyclohexylmethane diisocyanate (H12MDI).

12. The composition as claimed in claim 1, characterized in that the amount of coupling agent, expressed as dry matter and related to the sum of (a) and (b), is between 0.1 and 15% by weight, preferably between 0.1 and 12% by weight, better still between 0.2 and 9% by weight and in particular between 0.5 and 5% by weight.

13. The composition as claimed in claim 1, characterized in that the non-starchy polymer is chosen from ethylene/vinyl acetate copolymers (EVAs), polyethylenes and polypropylenes that are unfunctionalized or functionalized, in particular, with silane units, acrylic units or maleic anhydride units, thermoplastic polyurethanes (TPUs), polybutylene succinates (PBSs), polybutylene succinate-co-adipates (PBSAs), polybutylene adipate terephthalates (PBATs), styrene-butylene-styrene copolymers (SBSs), styrene-ethylene-butylene-styrene copolymers (SEBSs), preferably that are functionalized, in particular with maleic anhydride units, amorphous polyethylene terephthalates (PETGs), synthetic polymers obtained from biosourced monomers, polymers extracted from plants, from animal tissues and from microorganisms, which are optionally functionalized, and mixtures thereof.

14. The composition as claimed in claim 1, characterized in that it contains at least 33% of carbon of renewable origin within the meaning of the ASTM D6852 standard.

15. A method for preparing a starch-based composition as claimed in claim 1, characterized in that it comprises the following steps:
(i) selecting at least one granular starch and at least one plasticizer of this starch;
(ii) preparing a plasticized starchy composition (a) by thermomechanical mixing this granular starch and this plasticizer;
(iii) incorporating, into this plasticized starchy composition (a) obtained in step (ii), a non-starchy polymer (b) in an amount such that the plasticized starchy composition (a) represents at least 51% by weight and the non-starchy polymer (b) represents at most 49% by weight, these amounts being expressed as dry matter and related to the sum of (a) and (b); and
(iv) incorporating, into the composition thus obtained, at least one coupling agent comprising at least two functional groups, at least one of which is capable of reacting with the plasticizer and at least one other of which is capable of reacting with the starch and/or the non-starchy polymer,
the step (iii) possibly being carried out before, during or after step (iv).

16. The method as claimed in claim 15, characterized by the fact that it also comprises the drying of the composition obtained in step (iii), before the incorporation of the coupling agent, to a residual moisture content of less than 5%, preferably less than 1%, in particular less than 0.1% by weight.

17. A method for preparing a thermoplastic starchy composition comprising the heating of a starch-based composition as claimed in claim 1 to a sufficient temperature and for a sufficient duration in order to react the coupling agent, on the one hand, with the plasticizer and, on the other hand, with the starch of the plasticized starchy composition (a) and/or the non-starchy polymer (b).

18. A thermoplastic starchy composition capable of being obtained as claimed in the method of claim 17.

19. The thermoplastic starchy composition as claimed in claim 18, characterized in that it has an elongation at break greater than 40%, preferably greater than 80% and in particular greater than 90%.

20. The thermoplastic starchy composition as claimed in claim 18, characterized in that it has a maximum tensile strength greater than 4 MPa, preferably greater than 6 MPa and in particular greater than 8 MPa.

21. The thermoplastic starchy composition as claimed in claim 18, characterized by the fact that it has an insolubles content, after immersion in water for 24 hours at 20° C., at least equal to 90%, preferably at least equal to 95% by weight, and in particular at least equal to 98% by weight.

22. The thermoplastic starchy composition as claimed in claim 18, characterized in that it has, after immersion in water at 20° C. for 24 hours, a degree of swelling of less than 20%, preferably less than 12%, better still less than 6%.

23. The thermoplastic starchy composition as claimed in claim 18, characterized in that it has:
an insolubles content at least equal to 98%;
a degree of swelling of less than 5%;
an elongation at break at least equal to 95%; and
a maximum tensile strength greater than 8 MPa.

24. The thermoplastic composition as claimed in claim 18, characterized in that it is not biodegradable or not compostable within the meaning of the EN 13432, ASTM D6400 and ASTM 6868 standards.

25. The thermoplastic composition as claimed in claim 18, characterized in that it contains at least 33% of carbon of renewable origin within the meaning of the ASTM D6852 standard.
